(19) United States
(12) Patent Application Publication
(10) Pub. No.: US 2013/0173473 A1
(43) Pub. Date: Jul. 4, 2013

(54) DATA SYCHRONIZATION SYSTEMS AND METHODS

(71) Applicants: Daniel P. Birtwhistle, Fishers, IN (US); Igor Gejdos, Indianapolis, IN (US); Jochen Kohler, Walldorf (DE)

(72) Inventors: Daniel P. Birtwhistle, Fishers, IN (US); Igor Gejdos, Indianapolis, IN (US); Jochen Kohler, Walldorf (DE)

(73) Assignee: ROCHE DIAGNOSTICS OPERATIONS INC., Indianapolis, IN (US)

(21) Appl. No.: 13/608,196

(22) Filed: Sep. 10, 2012

Related U.S. Application Data
(60) Provisional application No. 61/580,702, filed on Dec. 28, 2011.

(51) Int. Cl. G06Q 50/22; G06F 21/00

(52) U.S. Cl. 705/50

(57) ABSTRACT

A method performed by a medical device includes: receiving electronic medical data from one or more input devices; storing the medical data in a first datastore associated with the medical device; receiving a non-expiring, cryptographic token from a server in response to a transmission of account data, the non-expiring, cryptographic token associated with the medical device for synchronizing the medical data stored in the first datastore with the medical data stored in the second datastore that is associated with the server; transmitting the non-expiring, cryptographic token to the server for authentication by the server; selectively transmitting at least a portion of the medical data stored in the first datastore to the server for storage in the second datastore; selectively receiving at least a portion of the medical data stored in the second datastore from the server; and selectively storing the medical data received from the server in the first datastore.

### CROSS-REFERENCE TO RELATED APPLICATIONS

This application claims the benefit of U.S. Provisional Application No. 61/580,702, filed on Dec. 28, 2011. The disclosure of the above application is incorporated herein by reference in its entirety.

### FIELD

The present disclosure relates to handheld medical devices and more particularly to data synchronization systems and methods for medical devices.

### BACKGROUND

Diabetes mellitus, often referred to as diabetes, is a chronic condition in which a person has elevated blood glucose levels that result from defects in the body's ability to produce and/or use insulin. There are three main types of diabetes. Type 1 diabetes usually strikes children and young adults, and can be autoimmune, genetic, and/or environmental. Type 2 diabetes accounts for 90-95% of diabetes cases and is linked to obesity and physical inactivity. Gestational diabetes is a form of glucose intolerance diagnosed during pregnancy and usually resolves spontaneously after delivery.

In 2009, according to the World Health Organization, at least 220 million people worldwide suffer from diabetes. In 2005, an estimated 1.1 million people died from diabetes. The incidence of diabetes is increasing rapidly, and it is estimated that between 2005 and 2030, the number of deaths from diabetes will double. In the United States, nearly 24 million Americans have diabetes with an estimated 25 percent of seniors age 60 and older being affected. The Centers for Disease Control and Prevention forecast that 1 in 3 Americans born after 2000 will develop diabetes during their lifetime. The National Diabetes Information Clearinghouse estimates that diabetes costs $132 billion in the United States alone every year. Without treatment, diabetes can lead to severe complications such as heart disease, stroke, blindness, kidney failure, amputations, and death related to pneumonia and flu.

Management of diabetes is complex because the level of blood glucose entering the bloodstream is dynamic. Variation of insulin in the bloodstream that controls the transport of glucose out of the bloodstream also complicates diabetes management. Blood glucose levels are sensitive to diet and exercise, but also can be affected by sleep, stress, smoking, travel, illness, menses, and other psychological and lifestyle factors that are unique to each patient. The dynamic nature of blood glucose and insulin, and all other factors affecting blood glucose, often require a person with diabetes to forecast blood glucose levels. Administration of insulin and/or oral medications can be regulated and timed to maintain blood glucose levels within an appropriate range at all times.

Management of diabetes is often highly intrusive because of the need to consistently obtain reliable diagnostic information, follow prescribed therapy, and manage lifestyle on a daily basis. Diagnostic information, such blood glucose level, can be obtained from a capillary blood sample with a lancing device and a test strip. The blood glucose level is measured via the test strip using a handheld blood glucose meter. Interstitial glucose levels can be obtained from a continuous glucose sensor worn on the body.

A therapy regimen for a patient can be established based on one or more of the patient's blood glucose levels. The therapy regimen can include administration of insulin and/or oral medication. Insulin can be administered with a syringe, an insulin pen, an ambulatory infusion pump, or a combination of two or more of the above. With insulin therapy, determining the amount of insulin to inject at a given time can require forecasting meal amount and composition (e.g., of fat, carbohydrates, and proteins, and amounts of each). Determining the amount of insulin to inject at a given time can also require consideration of the effects of exercise and physiologic state. The patient's management of lifestyle factors such as body weight, diet, and exercise can significantly influence the type and effectiveness of therapy.

Management of diabetes involves large amounts of diagnostic data and prescriptive data that are acquired from medical devices, personal health care devices, patient recorded information, health care professional tests results, prescribed medications and recorded information. Medical devices including self-monitoring bG meters, continuous glucose monitors, insulin infusion pumps, diabetes analysis software, and diabetes device configuration software each of which generates or manages or both large amounts of diagnostic and prescriptive data. Personal health care devices can include weights, scales, blood pressure cuffs, pedometers, other activity monitors, and other suitable devices. Patient recorded data can include information relating to meals, exercise, and lifestyle. Health care professional biomarker data can include HbA1C, cholesterol, triglycerides, fasting glucose, and glucose tolerance. Health care professional recorded information can include therapy and other patient-specific information.

Medical data for a patient can be stored at multiple locations. For example, the patient may store medical data pertaining to their management of their bG level in a first datastore using a personal computer. A health care provider (e.g., a doctor or other health care professional) may store medical data pertaining to the patient in a second datastore using a second personal computer. One or more other health care providers (e.g., a medical laboratory, etc.) may store medical data pertaining to the patient in a third datastore using a third personal computer. There is a need to synchronize the patient's medical data such that one or more complete sets of all of the patient's medical data are maintained.

The background description provided herein is for the purpose of generally presenting the context of the disclosure. Work of the presently named inventors, to the extent it is described in this background section, as well as aspects of the description that cannot otherwise qualify as prior art at the time of filing, are neither expressly nor impliedly admitted as prior art against the present disclosure.

### SUMMARY

In one feature, a method performed by a medical device for synchronizing medical data stored in a first datastore that is associated with the medical device with medical data stored in a second datastore that is associated with the server is described. The method includes: receiving electronic medical data from one or more input devices; storing the medical data in the first datastore; receiving account data input by a user, the account data including an identifier and a password for an account; transmitting the account data including the identifier and the password to a server; receiving a non-expiring, cryptographic token from the server in response to the transmission of the account data, the server associating the non-expiring, cryptographic token with the medical device for synchronizing the medical data stored in the first datastore with the medical data stored in the second datastore; and selectively synchronizing the medical data stored in the first datastore with the medical data stored in the second datastore. Selectively synchronizing the medical data stored in the first datastore with the medical data stored in the second datastore includes: transmitting the non-expiring, cryptographic token to the server for authentication by the server; selectively transmitting at least a portion of the medical data stored in the first datastore to the server for storage in the second datastore; selectively receiving at least a portion of the medical data stored in the second datastore from the server, the server transmitting the at least a portion of the medical data stored in the second datastore based on the association of the non-expiring, cryptographic token with the medical device; and selectively storing the medical data received from the server in the first datastore.

In another feature, a method performed by a server for synchronizing medical data stored in a first datastore that is associated with the server with medical data stored in a second datastore that is associated with a medical device is described. The method includes: receiving electronic medical data from one or more medical data sources; storing the medical data in the first datastore; receiving account data from the medical device, the account data input to the medical device by a user and including an identifier and a password for an account for the medical device at the server; selectively generating a non-expiring, cryptographic token in response to the transmission of the account data; creating an association between the medical device and the account for synchronizing the medical data stored in the first datastore with the medical data stored in the second datastore; and selectively synchronizing the medical data stored in the first datastore with the medical data stored in the second datastore. Selectively synchronizing the medical data stored in the first datastore with the medical data stored in the second datastore includes: receiving the non-expiring, cryptographic token from the medical device; performing an authentication function using the non-expiring, cryptographic token; selectively transmitting at least a portion of the medical data stored in the first datastore to the medical device for storage in the second datastore; selectively receiving at least a portion of the medical data stored in the second datastore from the medical device; and selectively storing the medical data received from the medical device in the first datastore.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a patient and a health care professional along with various devices that can be used to help the patient monitor and control health;

FIG. 2 shows a patient with a continuous glucose monitor (CGM), an ambulatory durable insulin infusion pump, an ambulatory non-durable insulin infusion pump, and a blood glucose (bG) management device;

FIG. 3 shows a diabetes care system of systems that can be used to manage diabetes;

FIG. 4 is a high level diagram of an example implementation of a handheld diabetes management device;

FIG. 5 is a functional block diagram of an example data synchronization system;

FIG. 6 is a flowchart depicting an example method of creating an account with a server;

FIG. 7 is a flowchart depicting an example method of establishing a pairing between an account and a medical device;

FIG. 8 is a flowchart depicting an example method of disabling an existing pairing between an account and a medical device;

FIG. 9 is a flowchart depicting an example method of synchronizing medical data received by a medical device and stored in a first datastore with medical data received by a server and stored in a second data store; and

FIG. 10 is a flowchart depicting an example method of creating an account with a server, establishing a pairing between an account and a medical device, synchronizing medical data received by a medical device and stored in a first datastore with medical data received by a server and stored in a second datastore, and disabling an existing pairing between an account and a medical device.

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method can be executed in different order without altering the principles of the present disclosure.

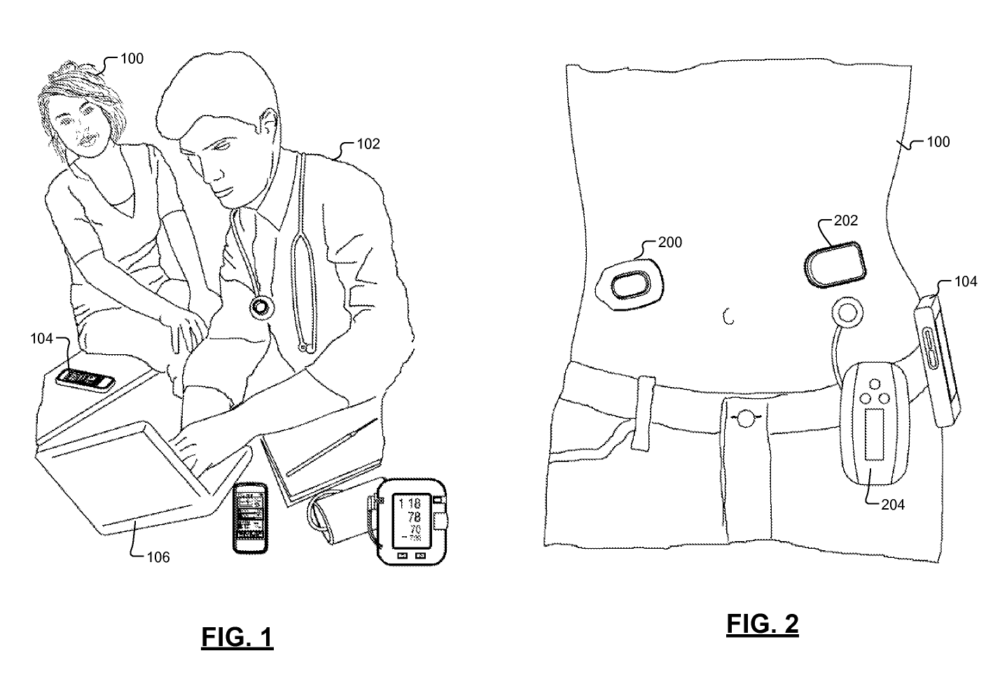

Referring now to FIG. 1, a patient 100 with diabetes and a health care professional 102 are shown in a clinical environment. The patient 100 with diabetes can be diagnosed with a metabolic syndrome, pre-diabetes, type 1 diabetes, type 2 diabetes, gestational diabetes, etc. Healthcare providers for diabetes are diverse and include nurses, nurse practitioners, physicians, endocrinologists, and others and are collectively referred to as health care professionals.

During a health care consultation, the patient 100 typically shares with the health care professional 102 a variety of data including blood glucose (bG) measurements, continuous glucose monitor data, amounts and type of insulin administered, amounts of food and beverages consumed, exercise schedules, health status, and other lifestyle information. The health care professional 102 can obtain additional data for the patient 100, such as measurements of HbA1C, cholesterol levels, plasma glucose, triglycerides, blood pressure, and weight. The data can be recorded manually or electronically on a handheld diabetes management device 104 (e.g., a handheld bG monitor device), a diabetes analysis software executed on a personal computer (PC) 106, and/or a web-based diabetes analysis site. The health care professional 102 can analyze the patient data manually or electronically using the diabetes analysis software and/or the web-based diabetes analysis site. After analyzing the data and reviewing how efficacious previously prescribed therapy is and how well the patient 100 followed the previously prescribed therapy, the health care professional 102 can decide whether to modify a therapy prescribed for the patient 100.

Referring now to FIG. 2, the patient 100 can use a continuous glucose monitor (CGM) 200, an ambulatory durable insulin infusion pump 204 or an ambulatory non-durable insulin infusion pump 202 (collectively insulin pump 204), and the diabetes management device 104. The CGM 200 can use a subcutaneous sensor to sense and monitor the amount of glucose (e.g., glucose concentration) of the patient 100. The CGM 200 communicates glucose measurements to the diabetes management device 104.

The diabetes management device 104 performs various tasks including measuring and recording bG measurements, determining an amount of insulin to be administered to the patient 100 via the insulin pump 204, receiving user input via a user interface, archiving data, performing structured bG tests, etc. The diabetes management device 104 can transmit instructions to the insulin pump 204, and the insulin pump 204 selectively delivers insulin to the patient 100. Insulin can be delivered in the form of a meal bolus dose, a correction bolus dose, a basal dose, etc.

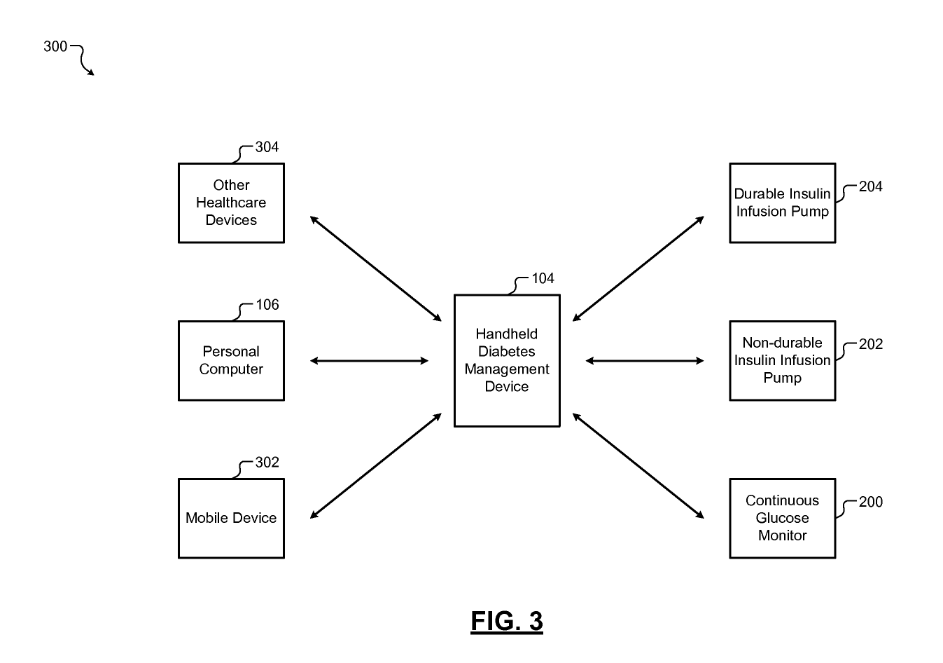

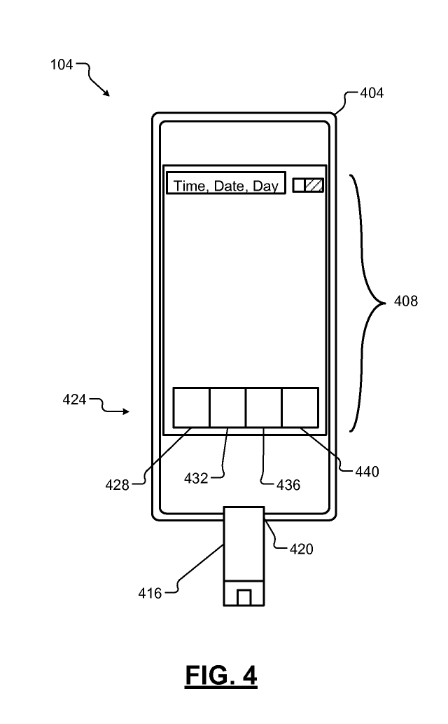

Referring now to FIG. 3, a diabetes management system 300 is shown which can be used by the patient 100 and/or the health care professional 102. The system 300 can include one or more of the following devices: the diabetes management device 104, the CGM 200, the insulin pump 204, a mobile device 302, the diabetes management software executed on the computer 106, and one or more other health care devices 304. The diabetes management device 104 can be configured as a system “hub” and communicate with one or more of the other devices of the system 300. The insulin pump 204, the mobile device 302, or another suitable device can alternatively serve as the system hub. Communication between various devices in the system 300 can be performed using wireless interfaces (e.g., Bluetooth) and/or wired interfaces (e.g., USB). Communication protocols used by these devices can include protocols compliant with the IEEE 11073 standard as extended using guidelines provided by Continua Health Alliance Design Guidelines. Further, health care records systems such as Microsoft HealthVault™ and Google Health™ can be used by the patient 100 and the health care professional 102 to exchange information.

The diabetes management software running on the computer 106 can include an analyzer-configurator that stores configuration information for devices of the system 300. For example only, the configurator has a database to store configuration information for the diabetes management device 104 and the other devices. A patient can interface the configurator through standard web based or computer graphical user interfaces (GUIs). The configurator selectively transmits patient-approved configurations to the devices of the system 300. The analyzer selectively retrieves data from the devices of the system 300, stores the data in a database, selectively analyzes the data, and outputs analysis results through standard web based or computer GUIs.

Referring now to FIG. 4, a high level illustration of an example embodiment of the diabetes management device 104 is presented. The diabetes management device 104 includes, among other things, a housing 404, user unit control switches (not specifically numbered), a touchscreen display 408, and a bG test strip port 420. The user unit control switches, for example, can include ON/OFF switches, volume switches, alarm switches for bG testing and/or insulin administration, and/or one or more other switches or other types of control devices that a patient can use to control functions/operations of the diabetes management device 104.

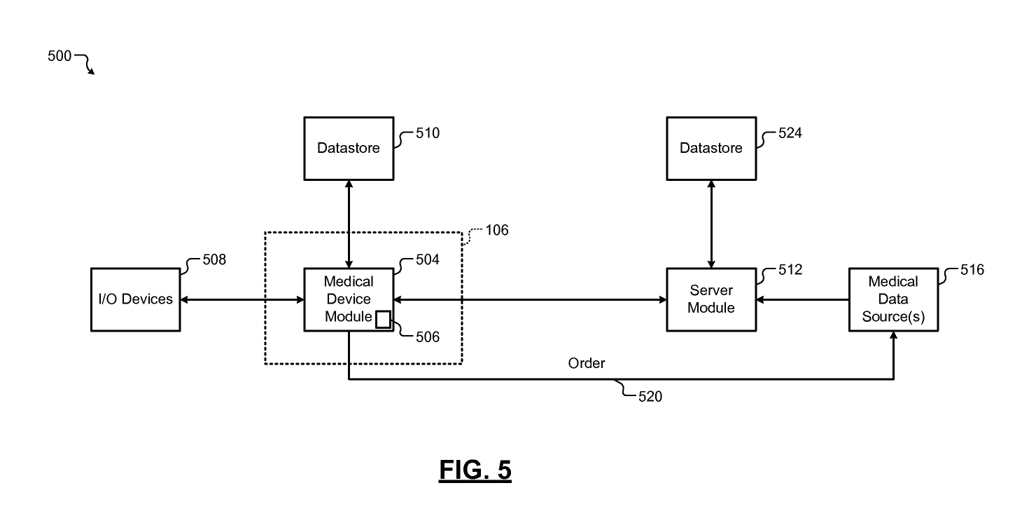

A bG test strip 416 can be inserted into the bG test strip port 420. The bG test strip 416 can be inserted into the bG test strip port 420 by a patient, from a test strip drum (not shown) located within the housing 404, or in another suitable manner. The bG test strip 416 is shown already inserted into the bG test strip port 420 in the example of FIG. 4 and not yet inserted into the bG test strip port 420 in the example of FIG. 5.

User selectable options 424 can be displayed on a portion of the display 408. The selectable options 424 can include a menu option 428, a bolus insulin option 432, a carbohydrate option 436, and an event option 440. One or more other user selectable options can additionally or alternatively be available. The patient can access a device menu for the diabetes management device 104 by selecting the menu option 428. The patient can input various insulin (and/or other medication) information (e.g., amount, insulin type, etc.) by selecting the bolus insulin option 432. The patient can input various carbohydrate intake information (e.g., amount) by selecting the carbohydrate option 436. The patient can also input other food intake information (e.g., protein content, fat content, etc.) by selecting the carbohydrate option 436. The patient can input various event related information (e.g., meals, exercise, periods of stress, etc.) that can affect the patient's bG measurements by selecting the event option 440.

Although the display 408 is described herein as a touchscreen display, the diabetes management device 104 can include another suitable form of display (e.g., LED, etc.). If a touchscreen display is not used, the user control switches can include specific buttons or controls by which the patient is able to select various options and input markers needed to operate the diabetes management device 104.

The above description is a broad description of the diabetes management device 104. In practice, the diabetes management device 104 can include additional controls, input ports, output ports, etc., as can be desired to further enhance its utility or its use with other components and devices (e.g., computers, infusion pumps, cellular phones, etc.). The description of the diabetes management device 104 should not be taken as limiting as to the construction of the diabetes management device 104 or as to the features and capabilities of the diabetes management device 104.

As used herein, the term “module” can refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term “module” can include memory (shared, dedicated, or group) that stores code executed by the processor.

The term “code,” as used herein, can include software, firmware, and/or microcode, and can refer to programs, routines, functions, classes, and/or objects. The term “shared,” as used above, means that some or all code from multiple modules can be executed using a single (shared) processor. In addition, some or all code from multiple modules can be stored by a single (shared) memory. The term “group,” as used above, means that some or all code from a single module can be executed using a group of processors. In addition, some or all code from a single module can be stored using a group of memories.

The apparatuses and methods described herein can be implemented by one or more computer programs executed by one or more processors. The computer programs include processor-executable instructions that are stored on a non-transitory, tangible, computer readable medium. The computer programs can also include stored data. Examples of the non-transitory, tangible, computer readable medium include, but are not limited to, nonvolatile memory, magnetic storage, and optical storage.

Referring now to FIG. 5, a functional block diagram of an example medical data synchronization system 500 is presented. A medical device module 504 executes a data collection/synchronization application 506 and receives electronic medical data. The functions described below that are performed by the medical device module 504 are performed during execution of the data collection/synchronization application 506.

The medical device module 504 may include, for example, a laptop computer, a desktop computer, a mobile device or tablet, or another suitable type of medical device that receives electronic medical data. The medical data may include, for example, electronic medical records (EMRs) and/or other electronically communicated medical data, such as bG related electronic medical records.

The medical device module 504 receives the medical data from one or more input/output (I/O) devices 508. The I/O devices 508 may include, for example, a keyboard, a mouse, a scanner/recognizer, one or more computers and/or servers, one or more medical devices, such as the diabetes management device 104, the CGM 200, the insulin pump 204, the mobile device 302, and/or one or more other suitable types of devices. The medical device module 504 stores the medical data in a datastore 510.

One or more users may operate the medical device module 504. The medical device module 504 may require a user of the medical device module 504 to input an identifier of the user and/or input a password for the user before the user can operate the medical device module 504. In various implementations, the medical device module 504 may check whether the user is authorized to execute the data collection/synchronization application 506 and, if not, the medical device module 504 may prevent execution of the data collection/synchronization application 506.

The medical device module 504 may communicate with a server module 512 via the internet or over one or more networks. For example, the medical device module 504 and the server module 512 may communicate using a SOAP (originally Simple Object Access Protocol) based communication scheme. The medical device module 504 and the server module 512 may communicate, for example, to create an account for the medical device module 504 with the server module 512, to synchronize medical data stored in the datastore 510 with medical data stored in a datastore 524 that is associated with the account, and one or more other reasons.

The server module 512 receives medical data from one or more medical data sources 516, such as one or more medical laboratories and/or one or more other suitable sources of electronic medical data. For example only, one of the medical data sources 516 may transmit medical data to the server module 512 in response to a user transmitting a medical data order 520 to the one of the medical data sources 516. The medical data order 520 may specify an identifier of the account of the medical device module 504, an identifier of the server module 512, and other suitable data. This information indicates to the one of the medical data sources 516 where to send the medical data, the account to which the medical data pertains, and other data (e.g., patient, etc.).

When transmitting the medical data to the server module 512, the one of the medical data sources 516 transmits an identifier of the account of the medical device module 504 and other data to the server module 512. The server module 512 can determine which account, patient, etc. that the medical data is to be associated with based on this data. The server module 512 stores the received medical data in the datastore 524 and associates the received medical data with the indicated account. While the medical device module 504 is shown and described as executing the data collection/synchronization application 506, the server module 512 could instead execute the data collection/synchronization application 506 and the exchanges of data could be reversed.

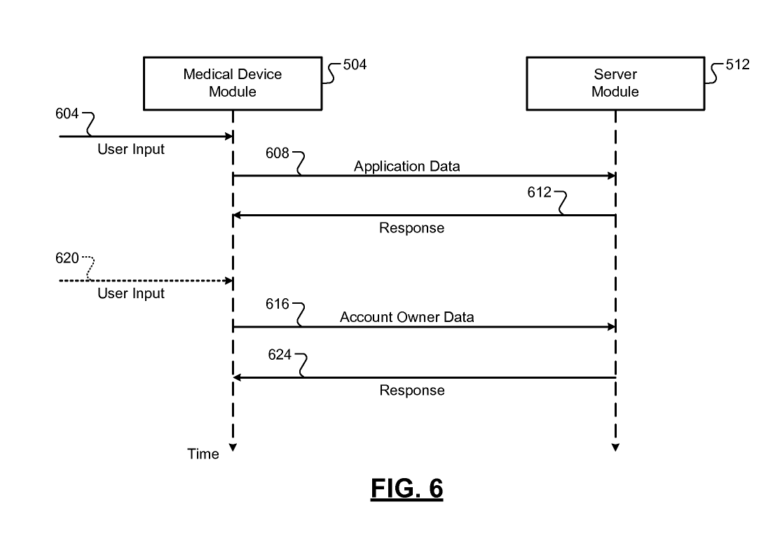

FIG. 6 includes an example flowchart depicting an example method of creating an account for the medical device module 504 with the server module 512. Once the account has been created with the server module 512, medical data for the account can be sent to the server module 512 and stored in the datastore 524 under the account. The medical device module 504 and the server module 512 may perform a synchronization to synchronize the medical data stored in the datastore 524 under the account with the medical data stored in the datastore 510. Synchronization includes storing medical data in each of the datastores 510 and 524 such that each of the datastores 510 and 524 includes all of the medical data that is stored in both of the datastores 510 and 524.

Referring now to FIGS. 5 and 6, a user may input account information data to the medical device module 504, as indicated by 604. The user may input account information to the medical device module 504, for example, using a keyboard, a mouse, a display, and/or one or more other suitable I/O devices.

When the user inputs a create account request, the medical device module 504 may transmit application data 608 to the server module 512. The application data 608 may include, for example, a version of the data collection/synchronization application 506, a product identifier of the data collection/synchronization application 506, and a region of the world where the medical device module 504 is located and executing the data collection/synchronization application 506 (e.g., a country). The application data 608 may also include other suitable data.

Based on the application data 608, the server module 512 determines whether the medical device module 504 is authorized to synchronize the medical data stored in the datastore 510 with medical data stored in the datastore 524. The server module 512 may determine whether the medical device module 504 is authorized to synchronize the medical data stored in the datastore 510 with medical data stored in the datastore 524, for example, by comparing the version, the product identifier, and the region with a table identified allowed versions, product identifiers, and regions, respectively. The medical device module 504 may not be authorized to synchronize the medical data stored in the datastore 510 with the medical data stored in the datastore 524 when the version, the product identifier, and/or the region is not one of the allowed versions, product identifiers, and/or regions, respectively. If the medical device module 504 is not authorized to synchronize the medical data stored in the datastore 510 with medical data stored in the datastore 524, the server module 512 may prevent creation of an account for the medical device module 504. The server module 512 generates a response 612 based on the application data 608 and transmits the response 612 to the medical device module 504. The response 612 indicates whether the medical device module 504 is authorized to synchronize the medical data stored in the datastore 510 with the medical data stored in the datastore 524.

When the medical device module 504 is authorized to synchronize with the server module 512, the medical device module 504 transmits account owner data 616 to the server module 512 for creating an account for the medical device module 504 with the server module 512. The account owner data 616 may be generated based on the user input 604 and/or additional user input 620. The account owner data 616 may include, for example, an account name, a unique identifier (e.g., GUID) of the datastore 510, a phone number, a first name, a last name, an email address, a location where the medical device module 504 is being used (e.g., a country, address, city, zipcode, etc.), a desired user name, and a desired password. The account owner data 616 may also include other suitable data.

The server module 512 selectively creates the account with the desired username and the desired password based on the account owner data 616 and predetermined account rules. The server module 512 generates a response 624 and transmits the response 624 to the medical device module 504. The response 624 indicates whether the account has been created according to the account owner data 616. If the account has not been created, the response 624 may indicate as much and indicate further information that is needed in order to create an account.

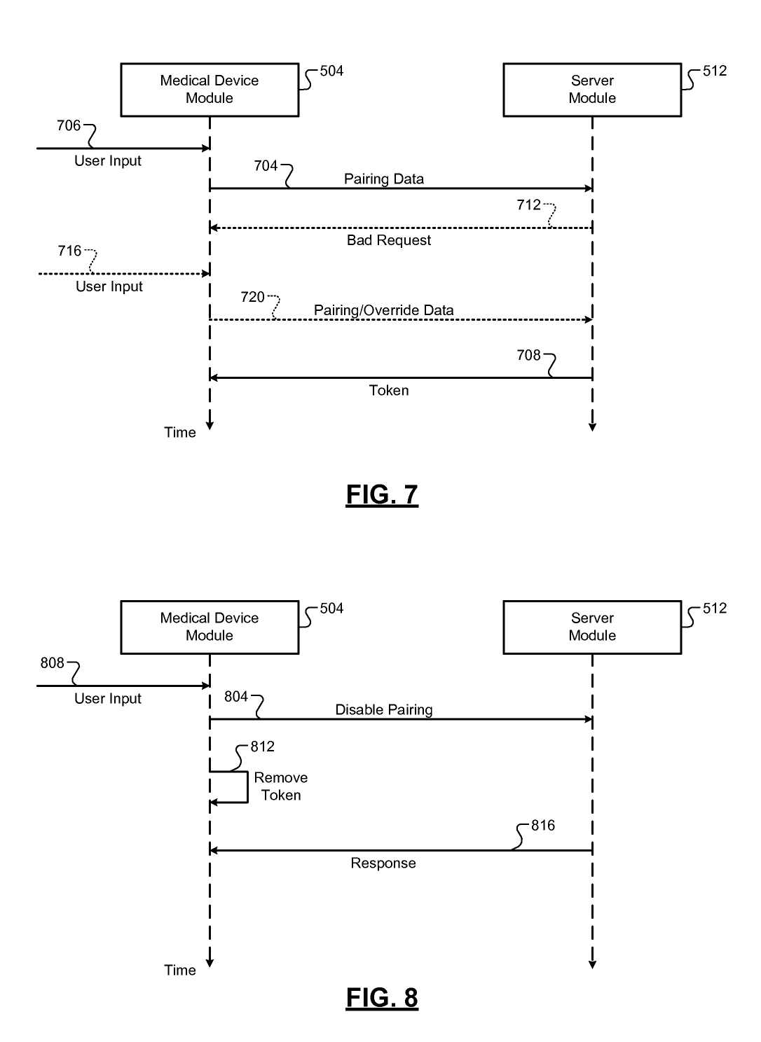

Referring back to FIG. 5, once the account has been created with the server module 512, the medical device module 504 is paired with the account before the medical data stored in the datastore 510 can be synchronized with the medical data stored in the datastore 524 for the account. FIG. 7 is a flowchart depicting an example method of pairing the medical device module 504 with the account.

Referring now to FIGS. 5 and 7, the medical device module 504 generates pairing data 704 and transmits the pairing data 704 to the server module 512. The medical device module 504 may generate and transmit the pairing data 704, for example, in response to user input 706. The user input 706 may indicate a request to pair the account with the medical device module 504. The pairing data 704 may include the unique identifier (e.g., GUID) of the datastore 510 and a unique identifier (e.g., GUID) of the datastore 524. The pairing data 704 also includes a username and a password input by the user and may include other suitable data.

The server module 512 generates a response based on the pairing data 704 and transmits the response to the medical device module 504. The response may be one of a cryptographic token 708 and a bad request 712. The server module 512 determines whether the username and password are associated with an account that exists (i.e., was previously created) with the server module 512. If so, the server module 512 selectively generates the token 708 and transmits the token 708 to the medical device module 504. The server module 512 also creates an association between the account and the medical device module 504.

The token 708 is a non-expiring (persistent) cryptographic token. Non-expiring, persistent cryptographic tokens do not include a time after which the token 708 will expire. For example, the token 708 may be a 128-byte cryptographic token or a 256 bit cryptographic token. The medical device module 504 builds the token 708 into the data collection/synchronization application 506. For example, the medical device module 504 may update the data collection/synchronization application 506 such that the token 708 is transmitted for authentication each time a synchronization is attempted. The medical device module 504 transmits the token 708 to the server module 512 for authentication by the server module 512 each time before the medical data stored in the datastore 510 is synchronized with the medical data stored in the datastore 524 for the account. The server module 512 can identify the medical device module 504 and the associated account based on the token 708, and the medical data can then be synchronized.

If the username and password are not associated with an account that exists with the server module 512, the server module 512 generates the bad request 712 to indicate that the username and/or password are invalid. The server module 512 may also generate the bad request 712 when one or more other conditions exist. For example, the server module 512 may generate the bad request 712 to indicate that the account that is associated with the username and password is already paired with another datastore or the datastore 510. Each account may be paired with one datastore at a time for purposes of the medical data synchronization described herein.

The medical device module 504 prompts the user for a decision whether to override the existing pairing when the bad request 712 indicates that the account is already paired with a datastore. The user provides user input 716 that indicates the user's decision on whether to override the existing pairing. If the user input 716 indicates that the user does not wish to override the existing pairing, the pairing process may end.

If the user input 716 indicates that the user's decision was to override the existing pairing, the medical device module 504 transmits pairing/override data 720 to the server module 512. The pairing/override data 720 includes the pairing data 704 and an override indicator. The server module 512 generates the token 708 in response to the pairing/override data 720.

A user of the medical device module 504 can disable an existing pairing between the medical device module 504 and an account. When the pairing is disabled, the server module 512 will reject authentication/synchronization attempts made using the token 708. FIG. 8 is a flowchart depicting an example method of disabling an existing pairing.

Referring now to FIG. 8, the medical device module 504 transmits disable pairing data 804 to the server module 512 in response to a user input 808 that indicates that the user has input a request to disable an existing pairing between the medical device module 504 and an account. The disable pairing data 804 may include the username and the password for the account, the unique identifier of the datastore 510, and the unique identifier of the datastore 524. The disable pairing data 804 may also include other data. The server module 512 disables the pairing between the account and the medical device module 504 in response to the disable pairing data 804. In this manner, the server module 512 will reject future authentication/synchronization attempts made using the token 708.

In response to the user input 808, the medical device module 504 may remove (e.g., delete) the token 708 as indicated by 812. Once removed, the token 708 cannot be used in the future for authentication/synchronization between the medical device module 504 and the server module 512. The server module 512 may transmit a response 816 to the medical device module 504, such as an acknowledgement, in response to the disable pairing data 804 to indicate that the server module 512 will rebuff future attempts for authentication/synchronization using the token 708.

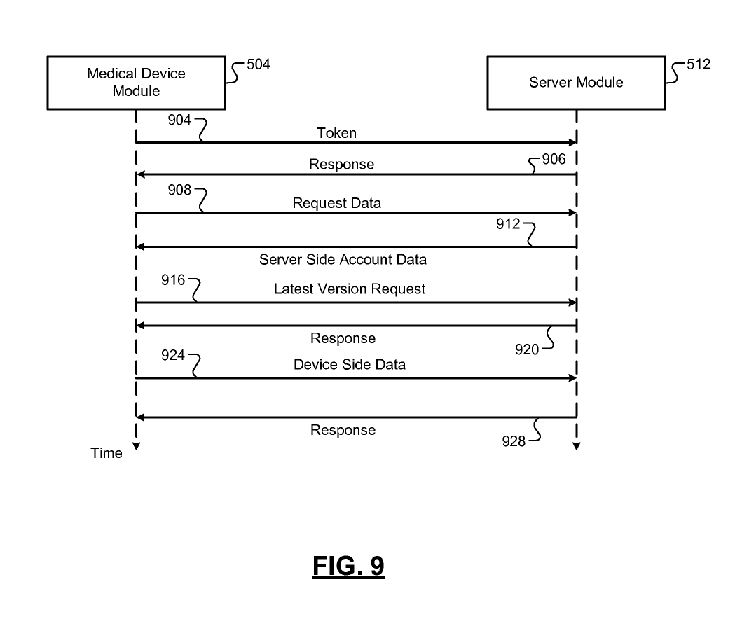

Referring now to FIG. 9, a flowchart depicting an example method of synchronizing data between the datastore 510 and the datastore 524 is presented. Synchronization of the medical data stored in the datastore 510 with the medical data stored in the datastore 524 for the account includes the server module 512 authenticating the token 708. Synchronization of the medical data stored in the datastore 510 with the medical data stored in the datastore 524 for the account also includes the medical device module 504 transmitting medical data that is not currently stored in the datastore 524 to the server module 512 for storage in the datastore 524 and includes the server module 512 transmitting medical data that is not currently stored in the datastore 510 to the medical device module 504 for storage in the datastore 510. Synchronizations may be performed, for example, at predetermined intervals (e.g., once per X units of time), each time when one or more predetermined events occur, etc.

Synchronization may begin by the medical device module 504 transmitting the token 708 to the server module 512 as indicated by 904. The server module 512 performs an (cryptographic) authentication function based on the token 708. The server module 512 may transmit a result of the authentication to the medical device module 504 as indicated by 906.

Each piece of medical data received by the medical device module 504 is stored in the datastore 510 with a current data version (e.g., value) that is maintained by the medical device module 504. The medical device module 504 may increment its current data version each time that a synchronization is completed. Each piece of medical data received by the server module 512 for the account is stored in the datastore 524 with a current data version (e.g., value) that is maintained by the server module 512 and is associated with the account. The server module 512 may increment its current data version each time that a synchronization is completed.

Once the token 708 has been authenticated, the medical device module 504 may transmit request data 908 to the server module 512. The request data 908 may include, for example, the current data version that is maintained by the medical device module 504. The request data 908 may also include other data.

The server module 512 identifies which pieces of medical data that are stored in the datastore 524 to transmit to the medical device module 504 based on the medical device module 504's current data version. For example, where the current data versions are incremented each time that a synchronization is compete, pieces of medical data with versions that are greater than the current data version should be transmitted to the medical device module 504. The server module 512 transmits those pieces of medical data, if any, to the medical device module 504 as indicated by 912. The medical device module 504 stores the pieces of medical data in the datastore 510.

The medical device module 504 may transmit a latest version request 916 to the server module 512. In response, the server module 512 may transmit its current data version to the medical device module 504 as indicated by 920. The medical device module 504 identifies which pieces of medical data that are stored in the datastore 510 to transmit to the server module 512 based on the server module 512's current data version. For example, where the current data versions are incremented each time that a synchronization is compete, pieces of medical data with versions that are greater than the current data version should be transmitted to the server module 512. The medical device module 504 transmits those pieces of medical data, if any, to the server module 512 as indicated by 924.

The server module 512 stores the pieces of medical data in the datastore 524 and associates the pieces of medical data with the account. The medical data stored within the datastore 524 for the account should then be the same as (i.e., synchronized with) the medical data stored within the datastore 510. The server module 512 may transmit a response 928, such as an acknowledgement, to the medical device module 504 in response to the receipt of the pieces of medical data.

A conflict may occur during synchronization if a piece of medical data was: (i) changed at the medical device module 504 and at the server module 512; or (ii) deleted by one of the medical device module 504 and the server module 512 and changed by the other one of the medical device module 504 and the server module 512. If a conflict is detected, the server module 512 and the medical device module 504 may be informed of the conflict. The conflict may be resolved in one of a plurality of ways. For example only, the medical data stored in the datastore 510 may always be updated based upon the medical data stored in the datastore 524. For another example only, the medical data stored in the datastore 524 may always be updated based upon the medical data stored in the datastore 510. For another example only, a creator of the piece of medical data may win and the other one of the datastores may be updated based upon the piece of medical data as stored in the database of the creator. For another example only, a user of the medical device module 504 may be prompted to choose. For another example only, the server module 512 may apply one or more rules to determine how to resolve the conflict. For another example only, the conflict can be ignored. For another example only, the version data can be used to resolve the conflict.

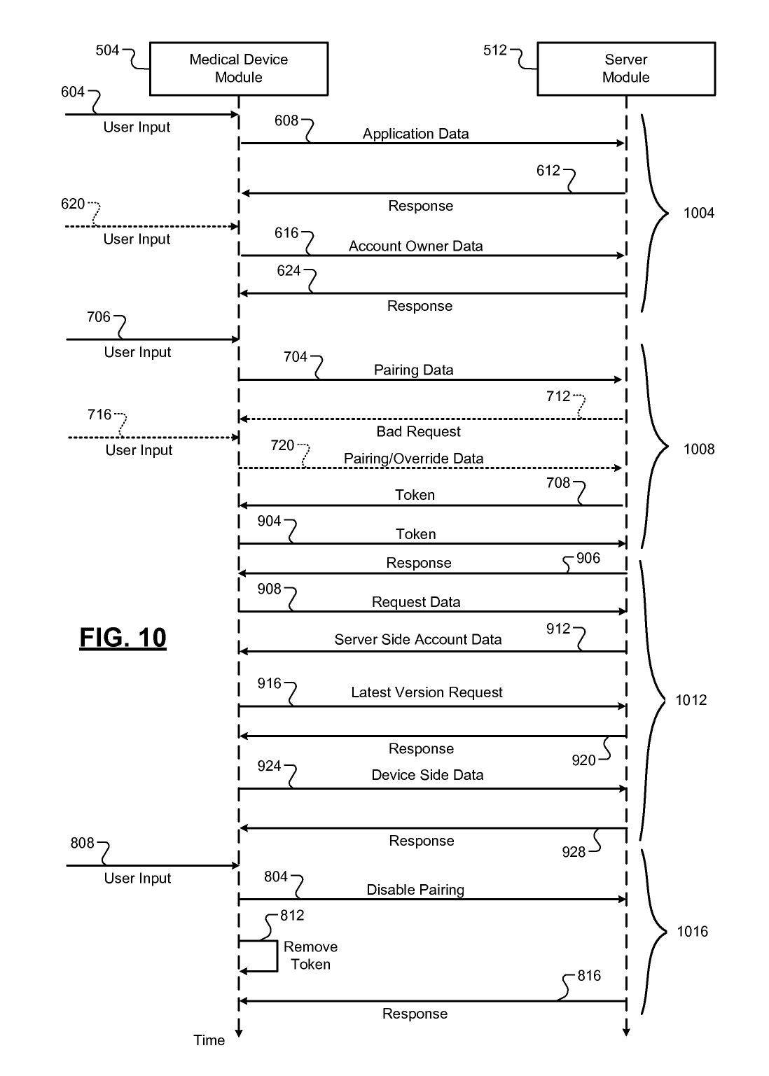

FIG. 10 includes a flowchart depicting an example method that may be performed using the medical device module 504 and the server module 512. The medical device module 504 and the server module 512 may communicate, as indicated by 1004, to establish an account for medical device module 504 with the server module 512. Once an account has been established with the server module 512, the medical device module 504 and the server module 512 may communicate as illustrated by 1008 to pair the account with the medical device module 504. The server module 512 generates and provides a token to the medical device module 504 as a result of the pairing. The medical device module 504 can later transmit the token back to the server module 512 for authentication and synchronization of the medical data stored in the datastore 510 with the medical data stored in the datastore 524 that is associated with the account.

Once the pairing between the account and the medical device module 504 has been established, the medical device module 504 and the server module 512 may synchronize the medical data stored in the datastore 510 with the medical data stored in the datastore 524 as illustrated by 1012. While one synchronization cycle is shown, the medical device module 504 and the server module 512 may synchronize the medical data stored in the datastore 510 with the medical data stored in the datastore 524 more than once. The server module 512 performs an authentication using the token 708 generated during the pairing before each synchronization.

Once the token 708 has been authenticated, the server module 512 transmits data that is not previously stored in the datastore 510 to the medical device module 504. The medical device module 504 stores the data in the datastore 510. Additionally, the medical device module 504 transmits medical data that I not previously stored in the datastore 524 for the account to the server module 512. The server module 512 stores the medical data in the datastore 524 in association with the account.

A user can disable the pairing between the account and the medical device module 504 to prevent future synchronizations as illustrated at 1016. To enable synchronizations after the pairing has been disabled, another pairing between the medical device module 504 and the account would need to be established before the medical data stored in the datastore 510 could be synchronized with the medical data stored in the datastore 524 for the account.

In one feature, a method performed by a medical device for synchronizing medical data stored in a first datastore that is associated with the medical device with medical data stored in a second datastore that is associated with the server is described. The method includes: receiving electronic medical data from one or more input devices; storing the medical data in the first datastore; receiving account data input by a user, the account data including an identifier and a password for an account; transmitting the account data including the identifier and the password to a server; receiving a non-expiring, cryptographic token from the server in response to the transmission of the account data, the server associating the non-expiring, cryptographic token with the medical device for synchronizing the medical data stored in the first datastore with the medical data stored in the second datastore; and selectively synchronizing the medical data stored in the first datastore with the medical data stored in the second datastore. Selectively synchronizing the medical data stored in the first datastore with the medical data stored in the second datastore includes: transmitting the non-expiring, cryptographic token to the server for authentication by the server; selectively transmitting at least a portion of the medical data stored in the first datastore to the server for storage in the second datastore; selectively receiving at least a portion of the medical data stored in the second datastore from the server, the server transmitting the at least a portion of the medical data stored in the second datastore based on the association of the non-expiring, cryptographic token with the medical device; and selectively storing the medical data received from the server in the first datastore.

In other features, the method further includes transmitting, to the server, an indicator of a location of the medical device, a version of a data synchronization application being executed on the medical device, and a unique identifier of the first datastore; receiving, from the server in response to the transmission of the unique identifier, the indicator of the location, and the version, a second indicator of whether synchronization of the medical data stored in the first datastore with the medical data stored in the second datastore is allowed; and selectively transmitting the account data including the identifier and the password for the account to the server in response to the second indicator of whether synchronization of the medical data stored in the first datastore with the medical data stored in the second datastore is allowed.

In still other features, the method further includes, in response to the receipt of the non-expiring, cryptographic token from the server, updating the data synchronization application based on the non-expiring, cryptographic token.

In further features, the non-expiring, cryptographic token is a 256 bit cryptographic token.

In still further features, the selectively transmitting at least a portion of the medical data stored in the first datastore to the server includes: identifying pieces of the medical data stored in the first datastore that are not currently stored in the second datastore; and transmitting, to the server, only the pieces of the medical data that are not currently stored in the second datastore.

In other features, the method further includes selectively transmitting a request to the server for disabling the association between the non-expiring, cryptographic token and the medical device to prevent future synchronizations of the medical data stored in the first datastore with the medical data stored in the second datastore.

In still other features, the method further includes deleting the non-expiring, cryptographic token from the medical device in response to input from the user.

In further features, the medical data stored in the first datastore includes blood glucose (bG) data.

In still further features, the method further includes: receiving desired account data from the user, the desired account data including a desired username and a desired password for the account; transmitting the desired account data including the desired username and the desired password to the server; receiving a response from the server, the response indicating whether the server created the account based on the desired account data; and selectively transmitting the account data including the username and the password to the server in response to the receipt of the response.

In other features, the desired account data further includes a name for the account, a location, a name, a phone number, and an email address.

In another feature, a method performed by a server for synchronizing medical data stored in a first datastore that is associated with the server with medical data stored in a second datastore that is associated with a medical device is described. The method includes: receiving electronic medical data from one or more medical data sources; storing the medical data in the first datastore; receiving account data from the medical device, the account data input to the medical device by a user and including an identifier and a password for an account for the medical device at the server; selectively generating a non-expiring, cryptographic token in response to the transmission of the account data; creating an association between the medical device and the account for synchronizing the medical data stored in the first datastore with the medical data stored in the second datastore; and selectively synchronizing the medical data stored in the first datastore with the medical data stored in the second datastore. Selectively synchronizing the medical data stored in the first datastore with the medical data stored in the second datastore includes: receiving the non-expiring, cryptographic token from the medical device; performing an authentication function using the non-expiring, cryptographic token; selectively transmitting at least a portion of the medical data stored in the first datastore to the medical device for storage in the second datastore; selectively receiving at least a portion of the medical data stored in the second datastore from the medical device; and selectively storing the medical data received from the medical device in the first datastore.

In other features, the method further includes: receiving an indicator of a location of the medical device, a version of a data synchronization application being executed on the medical device, and a unique identifier of the second datastore; determining whether synchronization of the medical data stored in the first datastore with the medical data stored in the second datastore is allowed based on the indicator of the location, the version, and the unique identifier; and transmitting, to the medical device, a second indicator of whether synchronization of the medical data stored in the first datastore with the medical data stored in the second datastore is allowed.

In still other features, the non-expiring, cryptographic token is a 256 bit cryptographic token.

In further features, selectively transmitting at least a portion of the medical data stored in the first datastore to the medical device includes: identifying pieces of the medical data stored in the first datastore that are not currently stored in the second datastore; and transmitting, to the medical device, only the pieces of the medical data that are not currently stored in the second datastore.

In still further features, the method further comprises: receiving a request from the medical device for disabling the association between the non-expiring, cryptographic token and the medical device to prevent future synchronizations of the medical data stored in the first datastore with the medical data stored in the second datastore; and removing the association in response to the receipt of the request.

In other features, the method further includes: receiving the non-expiring, cryptographic token from the medical device after receiving the request; performing an authentication function using the non-expiring, cryptographic token received after the request; and transmitting an indicator to the medical device that the authentication function failed.

In still other features, the method further includes refraining from transmitting medical data stored in the first datastore to the medical device after receiving the request.

In further features, the medical data stored in the first datastore includes blood glucose (bG) data.

In still further features, the method further includes: receiving desired account data from the medical device, the desired account data input to the medical device by a user and including a desired identifier and a desired password for the account; selectively creating the account based on the desired account data; and transmitting a response to the medical device, the response indicating whether the server created the account based on the desired account data.

In other features, the desired account data further includes a name for the account, a location, a name, a phone number, and an email address.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A method performed by a medical device for synchronizing medical data stored in a first datastore that is associated with the medical device with medical data stored in a second datastore that is associated with the server, the method comprising:
receiving electronic medical data from one or more input devices;
storing the medical data in the first datastore;
receiving account data input by a user, the account data including an identifier and a password for an account;
transmitting the account data including the identifier and the password to a server;
receiving a non-expiring, cryptographic token from the server in response to the transmission of the account data, the server associating the non-expiring, cryptographic token with the medical device for synchronizing the medical data stored in the first datastore with the medical data stored in the second datastore; and
selectively synchronizing the medical data stored in the first datastore with the medical data stored in the second datastore including:
transmitting the non-expiring, cryptographic token to the server for authentication by the server;
selectively transmitting at least a portion of the medical data stored in the first datastore to the server for storage in the second datastore;
selectively receiving at least a portion of the medical data stored in the second datastore from the server, the server transmitting the at least a portion of the medical data stored in the second datastore based on the association of the non-expiring, cryptographic token with the medical device; and
selectively storing the medical data received from the server in the first datastore.

2. The method of claim 1 further comprising:
transmitting, to the server, an indicator of a location of the medical device, a version of a data synchronization application being executed on the medical device, and a unique identifier of the first datastore;
receiving, from the server in response to the transmission of the unique identifier, the indicator of the location, and the version, a second indicator of whether synchronization of the medical data stored in the first datastore with the medical data stored in the second datastore is allowed; and
selectively transmitting the account data including the identifier and the password for the account to the server in response to the second indicator of whether synchronization of the medical data stored in the first datastore with the medical data stored in the second datastore is allowed.

3. The method of claim 2 further comprising, in response to the receipt of the non-expiring, cryptographic token from the server, updating the data synchronization application based on the non-expiring, cryptographic token.

4. The method of claim 1 wherein the non-expiring, cryptographic token is a 256 bit cryptographic token.

5. The method of claim 1 wherein the selectively transmitting at least a portion of the medical data stored in the first datastore to the server includes:
identifying pieces of the medical data stored in the first datastore that are not currently stored in the second datastore; and
transmitting, to the server, only the pieces of the medical data that are not currently stored in the second datastore.

6. The method of claim 1 further comprising selectively transmitting a request to the server for disabling the association between the non-expiring, cryptographic token and the medical device to prevent future synchronizations of the medical data stored in the first datastore with the medical data stored in the second datastore.

7. The method of claim 1 further comprising deleting the non-expiring, cryptographic token from the medical device in response to input from the user.

8. The method of claim 1 wherein the medical data stored in the first datastore includes blood glucose (bG) data.

9. The method of claim 1 further comprising:
receiving desired account data from the user, the desired account data including a desired username and a desired password for the account;
transmitting the desired account data including the desired username and the desired password to the server;
receiving a response from the server, the response indicating whether the server created the account based on the desired account data; and
selectively transmitting the account data including the username and the password to the server in response to the receipt of the response.

10. The method of claim 9 wherein the desired account data further includes a name for the account, a location, a name, a phone number, and an email address.

11. A method performed by a server for synchronizing medical data stored in a first datastore that is associated with the server with medical data stored in a second datastore that is associated with a medical device, the method comprising:
receiving electronic medical data from one or more medical data sources;
storing the medical data in the first datastore;
receiving account data from the medical device, the account data input to the medical device by a user and including an identifier and a password for an account for the medical device at the server;
selectively generating a non-expiring, cryptographic token in response to the transmission of the account data;
creating an association between the medical device and the account for synchronizing the medical data stored in the first datastore with the medical data stored in the second datastore; and
selectively synchronizing the medical data stored in the first datastore with the medical data stored in the second datastore including:
receiving the non-expiring, cryptographic token from the medical device;
performing an authentication function using the non-expiring, cryptographic token;
selectively transmitting at least a portion of the medical data stored in the first datastore to the medical device for storage in the second datastore;
selectively receiving at least a portion of the medical data stored in the second datastore from the medical device; and
selectively storing the medical data received from the medical device in the first datastore.

12. The method of claim 11 further comprising:
receiving an indicator of a location of the medical device, a version of a data synchronization application being executed on the medical device, and a unique identifier of the second datastore;
determining whether synchronization of the medical data stored in the first datastore with the medical data stored in the second datastore is allowed based on the indicator of the location, the version, and the unique identifier; and
transmitting, to the medical device, a second indicator of whether synchronization of the medical data stored in the first datastore with the medical data stored in the second datastore is allowed.

13. The method of claim 11 wherein the non-expiring, cryptographic token is a 256 bit cryptographic token.

14. The method of claim 11 wherein the selectively transmitting at least a portion of the medical data stored in the first datastore to the medical device includes:
identifying pieces of the medical data stored in the first datastore that are not currently stored in the second datastore; and
transmitting, to the medical device, only the pieces of the medical data that are not currently stored in the second datastore.

15. The method of claim 11 further comprising:
receiving a request from the medical device for disabling the association between the non-expiring, cryptographic token and the medical device to prevent future synchronizations of the medical data stored in the first datastore with the medical data stored in the second datastore; and
removing the association in response to the receipt of the request.

16. The method of claim 15 further comprising:
receiving the non-expiring, cryptographic token from the medical device after receiving the request;
performing an authentication function using the non-expiring, cryptographic token received after the request; and
transmitting an indicator to the medical device that the authentication function failed.

17. The method of claim 16 further comprising refraining from transmitting medical data stored in the first datastore to the medical device after receiving the request.

18. The method of claim 11 wherein the medical data stored in the first datastore includes blood glucose (bG) data.

19. The method of claim 11 further comprising:
receiving desired account data from the medical device, the desired account data input to the medical device by a user and including a desired identifier and a desired password for the account;
selectively creating the account based on the desired account data; and
transmitting a response to the medical device, the response indicating whether the server created the account based on the desired account data.

20. The method of claim 19 wherein the desired account data further includes a name for the account, a location, a name, a phone number, and an email address.
